(19) United States
(12) Patent Application Publication
(10) Pub. No.: US 2025/0264581 A1
(43) Pub. Date: Aug. 21, 2025

(54) RADAR SYSTEM AND METHOD IN RADAR RECEIVER

(71) Applicant: RENESAS ELECTRONICS CORPORATION, Tokyo (JP)

(72) Inventors: Gireesh Rajendran, Bengaluru (IN); Rakesh Kumar, Bengaluru (IN); Ashish Lachhwani, Bengaluru (IN); Vineeth Anavangot, Bengaluru (IN)

(73) Assignee: Renesas Electronics Corporation, Tokyo (JP)

(21) Appl. No.: 19/037,233

(22) Filed: Jan. 26, 2025

(30) Foreign Application Priority Data
Feb. 20, 2024 (IN) 202441011793

(51) Int. Cl. G01S 7/40; G01S 7/28; G01S 7/288; G01S 13/933; G06F 1/12

(52) U.S. Cl. CPC G01S 7/4021; G01S 7/2806; G06F 1/12; G01S 7/2883; G01S 13/933

(57) ABSTRACT

A radar system comprising a plurality of receivers, each receiver having its clock generator generating a clock signal with a sampling frequency for sampling a radar signal received on one or more receiving antennas and a plurality of delay estimation and compensation (DEC) blocks implemented within the corresponding plurality of receivers, wherein, each DEC block is configured to synchronise the clock generator of one receiver with every other receiver. A method in a radar comprising, generating a sync pulse in a first receiver in the plurality of receives, measuring a delay between the sync pulse and the clock signal in the first receiver, transmitting the sync pulse to other receivers in the plurality of receivers measuring a second delay between the sync pulse and the clock pulse in the other receivers and changing the frequency of the clock generator in the other receivers from the sampling frequency to first frequency for a first time duration.

### CROSS REFERENCES TO RELATED APPLICATION

This application claims Priority from Indian Patent Application No. 202441011793 filed on Feb. 20, 2024 which is incorporated herein in its entirety by reference.

### TECHNICAL FIELD

Embodiments of the present disclosure relate generally to Radar and Surveillance systems and more specifically to Radar system and method in radar receiver.

### RELATED ART

Radar systems are generally employed for object detection and increasingly used in various automotive applications such as for driver assistance, obstacle detection, avoidance, and navigation of drones/Unmanned Aerial Vehicles (UAVs), terrain mapping, autonomous vehicle control and radar imaging. As is well known, radars can detect surrounding obstacles or objects and send the relevant information like distance, relative position, direction and velocity of the object that are in motion/still to a controller (software or hardware) or to a decision making unit in the automotive device.

Often the radar system generates a set of points representing one or more detected objects in the three dimensional space. Each point is represented by the distance (range), Azimuth, and Elevation angles in the three dimensional space. The Azimuth and/or Elevation angle are often determined by measuring the angle of arrival (AoA) of the received (reflected) signal. In certain situations, the angle of arrival is determined in only one coordinate (say Azimuth or Elevation) and in certain other situations, the AoA is determined in both the coordinates.

As is well known, Radar system includes a transmitter and a receiver. The transmitter may transmit a sequence of pulses (as in pulsed radar systems) or may transmit a frequency modulated continuous wave (FMCW) signal (as in FMCW radar as is well known). The receiver may receive the corresponding signal reflected by objects (reflected signal) and processes it to determine one or more parameters such as range (distance), Doppler (velocity), Elevation/Azimuth angle (relative position) of one more object.

In some applications, more than one antenna may be employed for transmitting the radar signals and/or more than one antenna may be employed for receiving the reflected signal forming corresponding multiple channel (also referred to as physical channel) radar system. For example, when the number of transmitting antennas is N and number of receiving antennas is M, then the radar system is considered as N×M channels system as is well known. It is generally desirable to have large number of channels to enhance the angular resolution (resolution of AoA).

Generally, multiple receivers (Integrated Circuits (ICs) with a fixed processing capability) are employed to process the signal received from plurality of channels when the number of channels is high or when angular resolution is required to be high. However, such configuration or system of multiple ICs exhibit limitation in terms of synchronised processing. In particular, the challenge arises in data sampling alignment across the ICs.

In one conventional approach to synchronise the clocks of multiple ICs in an imaging radar system, a Clock fan-out buffer is configured to receive the Analog to digital converter (ADC) clock from the primary IC and fan-out to all devices including the primary and secondary ICs in the system. This known technique suffers from the fact that it requires additional high speed, low noise clock fan-out buffers on the PCB that increases the cost and complexity. Secondly, it also suffers from the fact that any systemic mismatch like PCB routing mismatch or a clock delay mismatch between ICs with temperature cannot be easily compensated.

In another approach (more fully described in the US patent publication number 20200003862A1), a Radar Frame Start (RFS) signal is embedded in the high frequency master slave (MS) clock. A demodulator incorporated inside the IC is configured to extract the RFS signal to synchronise the sampling start of master and slave devices. This technique also suffers similar disadvantages as noted above and become more complex or impractical when requirement is more stringent like, a misalignment of one clock cycle will cause 180 deg phase error at band edge, assuming Nyquist rate sampling. To maintain the phase error within +/−3 deg for a 50 MHz bandwidth system, the sampling mismatch should be within 166 ps.

### SUMMARY

According to an aspect, a radar system comprising a plurality of receivers, each receiver having its clock generator generating a clock signal with a sampling frequency for sampling a radar signal received on one or more receiving antenna and a plurality of delay estimation and compensation (DEC) blocks implemented within the corresponding plurality of receivers, wherein, each DEC block is configured to synchronise the clock generator of one receiver with every other receiver.

According to another aspect, a method in a radar receiver implemented with a plurality of receivers with each receiver having its own clock generator generating a clock signal with a sampling frequency for sampling a radar signal received by the respective receivers in the plurality of receivers, the method comprising, generating a sync pulse in a first receiver in the plurality of receiver, measuring a delay between the sync pulse and the clock signal in the first receiver transmitting the sync pulse to other receiver in the plurality of receivers measuring a second delay between the sync pulse and the clock pulse in the other receiver and changing a the frequency of the clock generator in the other receiver from the sampling frequency to first frequency for a first time duration.

Several aspects are described below, with reference to diagrams. It should be understood that numerous specific details, relationships, and methods are set forth to provide a full understanding of the present disclosure. One who is skilled in the relevant art, however, will readily recognize that the present disclosure may be practiced without one or more of the specific details, or with other methods, etc. In other instances, well-known structures or operations are not shown in detail to avoid obscuring the features of the present disclosure.

### BRIEF DESCRIPTION OF DRAWINGS

FIG. 1 is a block diagram of an example radar system 100 (environment) in which various aspects of the present invention may be seen.

FIG. 2 is an example radar transceiver for object detection and recognition in an embodiment.

FIG. 3 is a block diagram illustrating example implementation of plurality of receivers in an embodiment.

FIG. 4 is a block diagram of a system employing multiple receivers (chips) of the present embodiment.

FIG. 5 is a block diagram illustrating the manner in which the clock generator 450 in all the receivers 410A-410K may be synchronized for data sampling.

### DETAILED DESCRIPTION OF THE PREFERRED EXAMPLES

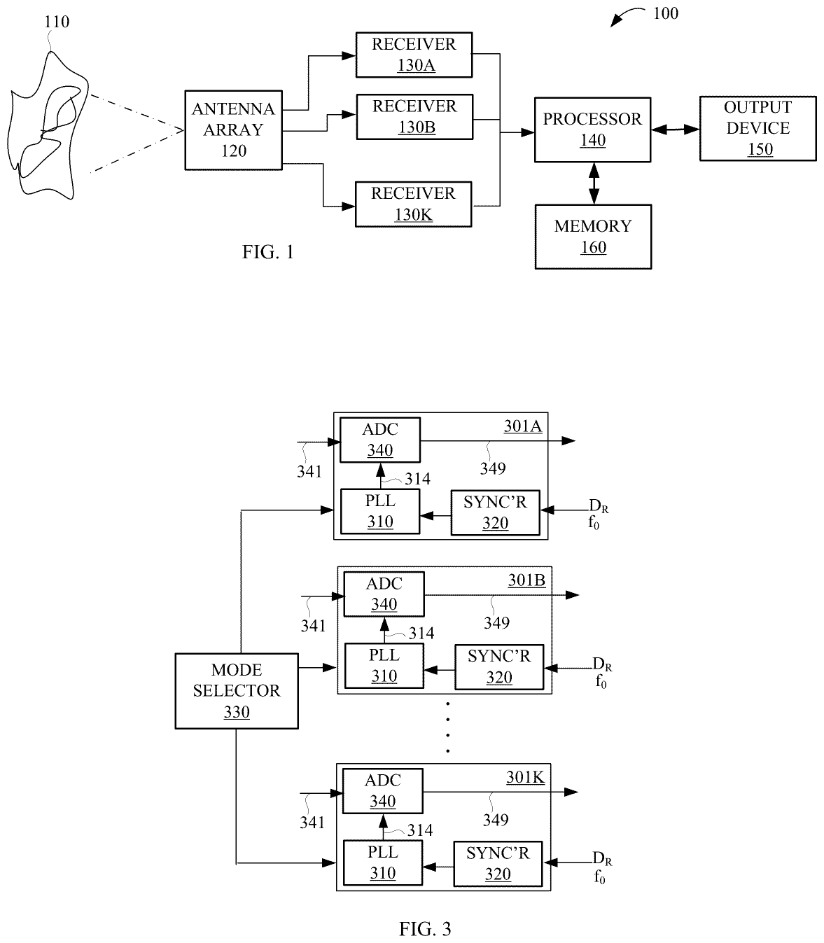

FIG. 1 is a block diagram of an example radar system 100 (environment) in which various aspects of the present invention may be seen. The environment is shown comprising objects 110, antenna array 120, receivers 130A-130K, processor 140, output device 150 and memory 160. Each element in the system 100 is further described below.

The antenna array 120 comprising plurality of antennas (may be geometrically arranged in a specific one or two dimensional array form) receive reflected radar signal that is reflected by the objects 110. As shown in the figure, a subset of antennas in the antenna array 120 is coupled to the receivers 130A-130K. Thus, each receiver may receive signal from one or more antennas in the antenna array 120. In this case, a transmitter transmitting the radar signal is not shown for brevity and not to obscure the invention that mostly resides in the radar receiver.

The receivers 130A-130K are configured to sample the signal received on the antennas coupled to them and provide the samples for further processing. In certain embodiment, the receivers may comprise signal processing elements such as Fast Fourier Transformer (FFT) that perform FFT operation on the received samples to generate or determine the range/doppler. In an alternative embodiment, the samples may be provided to the processor 140 for determining the range Doppler and Angle of Arrival (AoA).

The processor 140 conditions and processes the samples received from the receivers 130A-130K to detect one or more objects (for example 110) and determines one or more parameters of the objects. The parameters of the object thus determined (like range, Doppler/velocity and position/AoA) are provided to the output device 150. In one embodiment, the processor 140 may employ samples received from all the receivers 130A-130K to determine the angle with high resolution. Alternatively, the processor 140 may use samples from one or more than one receivers 130A-130K to determine the angle with correspondingly high resolution as compared to determining the angle using samples from one receiver alone. In certain embodiment, the processor 140 may determine Doppler and range also from the samples received from one or more receivers 130A-130K.

In certain embodiment the receiver 130A-130K may comprise certain processing power to process the samples generated by the respective receiver and determine range and/or Doppler, when the samples so generated is received over multiple chirps or frame as is known in the relevant art. The range and Doppler information along with the samples may be forwarded to the processor 140 for determining the angle with higher resolution. The processor 140 may use the samples of the signals received over larger number of antennas (combinedly received by the receivers 130A-130K) forming improved aperture for detecting the angle with higher resolution. The memory 160 may store the data such as range, Doppler and samples for further processing and the result of the computation, intermittently and or permanently for other devices to access the result of detection of the objects and its parameters/characteristics. The output device 150 may comprise, controlling device operative to navigate the vehicle, Unmanned Aerial Vehicle (UAVs) or any unmanned vehicles or vehicles with driver assisting devices. The output device 150 comprises navigation control electronics operative to navigate the vehicle, UAVs or any unmanned vehicles or vehicles with driver assisting devices, display device, decision making electronic circuitry, traffic management system, vehicular management systems, toll collection system and other controllers/systems for navigation, display and further processing the information received from the processor 140 for obstacle detection, navigation and control, terrain mapping and radar imaging.

In one embodiment, each receiver 130A-130K may be an integrated circuit built with a fixed number of antenna interface points. For example, each of the receivers 130A-130K may comprise 4 receive antenna interface points. By using two or four such receivers, an 8 or 16 receive channel radar may by be built. Thus, even though the signal received over one IC (receiver) may provide limited resolution for determination of angle as the aperture of the receiver (determined based on the number of antenna and its cross sectional area) is limited, by combing desired number of ICs it is possible to obtain the necessary angle resolution.

In an embodiment, the processor 140 may comprise group of signal processing blocks each performing the specific operations on the received signal and together operative to detect object and its characteristics/properties. For example, the processor may comprise data processing blocks/signal processing blocks like FFT engine.

The output device 150 comprises navigation control electronics, display device, decision making electronic circuitry, traffic management system, vehicular management systems, toll collection system and other controllers/systems for navigation, display and further processing the received details of the objects. Accordingly, the system 200 may be deployed as part of unmanned vehicles, driver assistant systems, for obstacle detection, navigation and control, terrain mapping, traffic control, toll control etc. An example implementation of the receiver 130A-130K and the processor 140 is further described below.

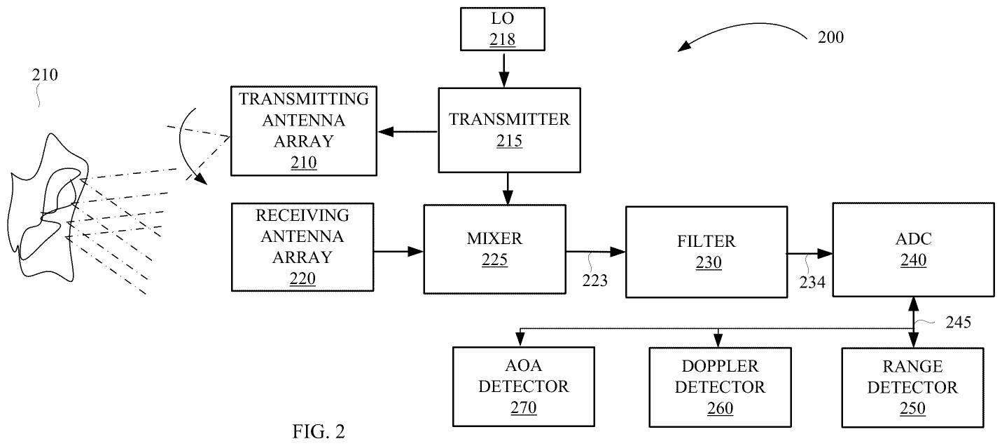

FIG. 2 is an example radar transceiver for object detection and recognition in an embodiment. The radar transceiver 200 is shown comprising transmitting antenna array 210, transmitter block 215, receiving antenna array 220, mixer 225, filter 230 Analog to digital convertor (ADC) 240, range detector 250, doppler detector 260 and AoA detector 270. Each element is described in further detail below.

The transmitting antenna array 210 and the transmitter 215 operate in conjunction to transmit RF signal over a desired direction. The transmitter 215 generates a radar signal for transmission and provides the same to the transmitting antenna array 210 for transmission. The transmitting antenna array 210 is employed to form a transmit beam with an antenna aperture to illuminate objects at suitable distance and of suitable size. Various known beam forming techniques may be employed for changing the illuminated region. The transmitter 215 may generate a radar signal comprising sequence of pulses (as in pulsed radar system) and/or sequence of chirps as in Frequency Modulated Continuous Wave (FMCW) radar system.

The receiving antenna array 220 comprises antenna elements each element capable of receiving reflected RF signal. The receiving antenna array 220 is employed to form an aperture to detect objects with a desired resolution (for example object of suitable size). The RF signal received on each element corresponding to one transmitted RF signal (either pulses or chirps) is provided to the mixer 225.

In that, the radar system 200 forms the N×P channel when the number of transmitting antennas in the array 210 is N and when the number of receiving antennas in the antenna array 220 is P. Further, every receiver 130A-130K comprises the mixer, 225, filter 230 and ADC 240 as part of the receiving and sampling electronics.

Wherein: The mixer 225 mixes RF signal received on each antenna element in the array with the transmitted RF signal (local oscillator frequency) to generate an intermediate frequency (IF) signal. In that the mixer 225 may comprise number of complex or real mixers to mix each RF signal received on the corresponding antenna elements. The IF signal is provided on path 223 to filter 230. The filter 230 passes the IF signal attenuating the other frequency components (such as various harmonics) received from the mixer. The filter 230 may be implemented as a pass band filter to pass a desired bandwidth (in conjunction with chirp bandwidth). The filtered IF signal is provided on path 234 to ADC 240. The ADC 240 converts IF signal received on path 234 (analog IF signal) to digital values. The ADC 240 may sample the analog IF signal at a sampling frequency Fs and convert each sample value to a bit sequence or binary value. The digitized samples of IF signal (digital IF signal) is provided for further processing.

The processor 140 may comprise the range detector 250, Doppler detector 260 and AoA detector 270. Alternatively, the range detector 250 may be integrated into the receiver 130A-130K such that, each receiver also provides range information. In yet another alternative possibility, all three detectors 250, 260 and 270 may be built inside the receiver 130A-130K such that each receiver produces the range, Doppler and AoA when independently used. In that case, AoA may be of low resolution.

As an alternative arrangement, the processor 140 may comprise AoA detector 270 alone or in combination with 250 and 260 as may be desired. Wherein, the range detector (FFT) 250 detects the range from the received signal. For example, the range detector 250 may perform FFT on the digital IF samples to generate plurality of ranges of the plurality reflected signals (from objects 110). In particular, range FFT 250 performs FFT on digital IF signal corresponding to each chirp. The range FFT 250 produces peaks representing the ranges of the plurality of reflecting points on the objects. The Doppler detector 260 detects the Doppler (or velocity) of the each ranges (points on one or more objects) detected in block 250. For example, the Doppler detector 260 may perform FFT operation on the ranges across chirps. The peaks in the Doppler FFT represent the Doppler of the plurality of reflecting points (of objects) or the velocity of the objects. The ranges and Doppler corresponding to plurality of reflecting points on the objects are provided to the AoA detector 270. The AoA detector 270 detects position of each reflecting point on the objects and presents a set of points in azimuth or elevation or both. For example, the AoA detector determines the angle of arrival of reflected signal (position/location) and estimates the azimuth and/or elevation of the reflected signal (from the objects) as points to form the point cloud representing the object(s). The AOA employs the data received over the antenna array to determine the angle of arrival based on the phase/time difference of the signal between successive antennas as is well known. Determination of angle of arrival and the dependency of the resolution of the angle of arrival on the number of antenna elements is not described in detail as being well known and also not to obscure the invention. However if the sampling instance in the receivers 130A-130K are not synchronized or not sampled at same instance, the desired resolution may be limited by the synchronization error. Accordingly, in one embodiment, the sampling instance of 130A-130K are synchronized with each other to enhance the resolution. The manner in which the receivers 130A-130K are implemented for enhanced synchronous sampling (sampling at substantially same instance in all integrated circuit 130A-130K) is further described below.

FIG. 3 is a block diagram illustrating example implementation of plurality of receivers in an embodiment. Each receiver 301A-301K are shown comprising phase locked loop 310, synchronizer (SYNC'R) 320 and ADC 340. In the embodiment, the mode selector 330 is shown outside the receiver 301A-301K. The mode selector may be implemented as part of the processor 140 or may be implemented within one of the receiver operative as primary receiver in the system. In one embodiment, the mode selector 330 is configured to operate the respective receiver 301A-301K in a calibration mode or in a functional mode. In the functional mode, the PLL shall drive the ADC 340 with a clock frequency/sampling frequency f₀. In calibration mode the, the ADC 340 may be disabled (made non operative by setting enable and disable bits), while the PLL 310 output is synchronized in time with PLLs of all receiver 301A-301K.

In each receiver 301A-301K: The phase locked loop (PLL) 310 generates the clock signal for operating the ADC 340. The PLL 310 may generate clock signal at a desired sampling frequency f₀. The synchronizer 320 is shown receiving external reference data DR and the PLL clock f₀ and providing a control signal to the PLL 310. The ADC 340 is shown receiving IF signal on path 341, clock signal on path 314 and providing digital samples on path 349. The clock signal on path 314 is received from PLL 310 in the operational/functional mode. The IF signal on path 341 may be the IF signal provided by Mixer 225. In general, the signal on 341 may be analog radar signal received on the antenna and down converted for digital processing. The ADC 340 may sample the signal on path 341 at every rising (or falling) edge of the clock signal 314. The sampled value is digitized and provided for processing to processor 240 (or to internal processor in the receivers 130A-130K) for determining the range, Doppler and/or AOA.

In one embodiment, the synchronizer 320 is configured to synchronize the rising edge of the clock 314 in all the receivers 301A-301K. In that, the external reference data DR is compared with the PLL output 314 in the calibration mode. The PLL output is adjusted in relation to the received external reference data DR to synchronize rising/falling edge of the PLL 310 in all the receiver 301A-301K. Thus, in the operational/functional mode, every receiver 301A-301K is configured to sampling the received antenna signal by its own PLL clock signal that is synchronized with other PLLs in the calibration mode. In one embodiment, the external reference data may comprise a reference pulse and a reference Delay value. Accordingly, the synchronizer may adjust the PLL output in relation to the reference pulse and the delay. The manner in which, plurality of receivers may be interconnected to operate synchronously is further described below.

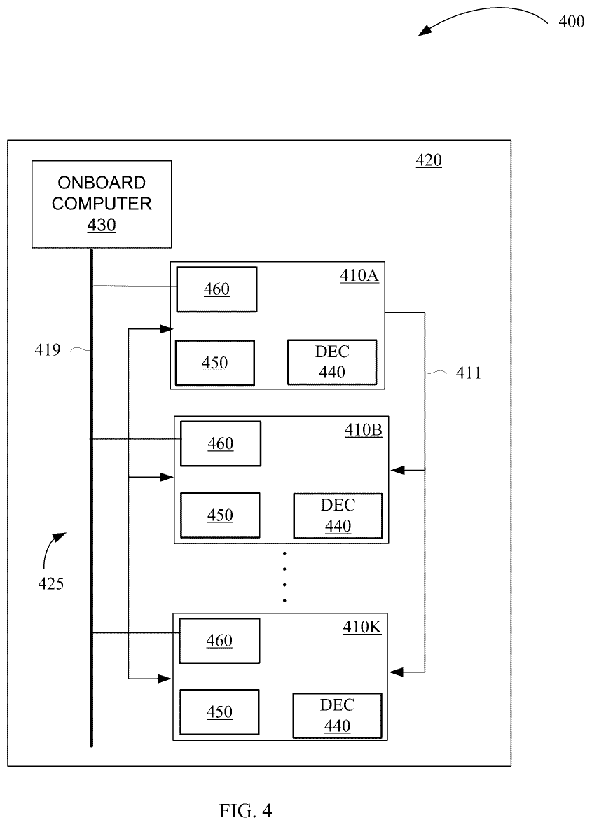

FIG. 4 is a block diagram of a system employing multiple receivers (chips) of the present embodiment. The system 400 is shown comprising receivers 410A-410K, printed circuit board (PCB) 420, and on-board computer 430. In the receiver 410A-410K, the receiver 410A is operative as primary receiver and receiver 410B-410K are operative as secondary receivers. Each receiver is shown comprising delay estimation and compensation (DEC) block 440, clock generator 450 and computing resource 460. The receivers are coupled to each other as shown in the Figure through layout 425 on the PCB 420.

The on-board computer 430 may be interfaced with each receiver 410A-410K for controlling the operation of the receivers. The on-board computer 430 may exchange information and write data to respective memory (not shown) for operations as desired. The PCB 420 operates to interconnect the devices (like receivers, computers and other peripheral electronics as well known) and provide support for placement of the devices. Interconnects (also referred to as layout 425) for transferring the signals between the devices, are etched on multiple layer of the PCB. Thus, each of the elements 410A-410K and 430 may be integrated circuits or IC chips with interface pins or terminals. In an alternative embodiment, the system 400 may be an SoC (System on Chip) with receiver's 410A-410K integrated over silicon substrate instead of PCB.

The primary receiver 410A is shown generating a Sync pulse on path 411 that is coupled to all the secondary receivers 410B-410K in a star connection manner and the computing resource 460 is shown coupled to corresponding computing resources in the receivers 410B-410K for transferring the delay information on path 419. The delay information may also be transferred to on-board computer 430 and intern to the receivers. In one embodiment, the Sync pulse and the delay information together constitute external reference data DR.

The primary receiver 410A may be configured to generate a sync pulse and measure the delay of the sync pulse with respect to its own PLL output (clock generator 450). The measured delay may represent the delay information. For example, the primary receiver 410 may measure the delay between the rising edge of the sync pulse and the rising edge of the clock signal. The measured delay is provided as the delay information. The sync pulse may be routed to the other receivers through PCB layout while the delay information may be transferred through any known data transfer protocols configured between the receivers and/or on-board computer 430. Alternatively, the sync pulse may be generated outside the primary receiver and routed to primary and secondary receiver on the PCB.

The clock generator 450 is configured to generate or provide clock signal with (sampling) frequency f₀ (to ADC) for sampling the signal received on the corresponding antenna. The clock generator may be a PLL clock generator implemented with known technology. It may be appreciated that, the PLL clock generator provides for varying the frequency by one of the known methods like changing the feedback divider division ratio.

The DEC 440 is configured to synchronize (adjust the timing of the rising edge) the clock generated by the clock generator 450 with the sync pulse in the calibration mode. The manner in which the DEC 440 may synchronize the clock signal is further described below.

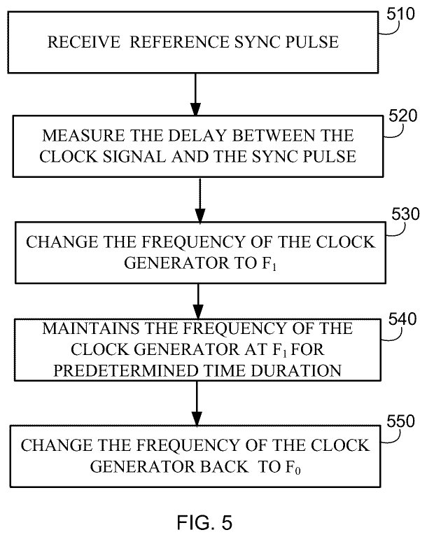

FIG. 5 is a block diagram illustrating the manner in which the clock generator 450 in all the receivers 410A-410K may be synchronized for sampling. In the block 510, the DEC 440 receives the reference sync pulse. The reference sync pulse may be a set of pulse or a single pulse with a rising and falling edge.

In the block 520, the DEC 440 measures the delay between the clock signal and the sync pulse. The delay may be measured with respect to the rising edge of the sync pulse and the nearest rising edge of the clock signal. The delay measured in each receiver 410A-410K may be represented as Δt_{A} through Δt_{K} respectively. In an embodiment, when the receiver 410A is operative as primary receiver, the Δt_{A} may be provided as the delay information that is the delay measured by the DEC of the receiver 410A of its clock signal with respect to the sync pulse. Each delay Δt_{A} through Δt_{K} may be of different value due to clock buffer inside the ICs and their delay. The delay in PCB experienced by each sync pulse reaching the corresponding receivers 410A-410K may be the same or substantially same as the routing length may be substantially same due to positioning of the chips.

In the block 530, the DEC 440 changes the frequency of the clock generator to F₁. In one embodiment, the DEC 440 in each receiver may compute the difference between the delay information and the measured delay. For example, when the delay information is equal to Δt_{A} (410A being primary), then the DEC in the receiver 410B may compute the difference τ as Δt_{B}-Δt_{A}. Value of t may be different for each receiver 410B-410K.

In the block 540, the DEC 440 maintains the frequency of the clock generator at a value say F₁ for predetermined time duration. The predetermined time duration for a selected frequency F1 may be determined using relation: τ=T*(1/Fo−1/(Fo+ΔF)), wherein the T is the pre-determined time and Fo+ΔF is F₁. The frequency F₁ is selected with very small change from the desired sampling frequency F₀. As a result of changing the frequency for the time duration, a delay is introduced to the clock signal.

In other words, the delay estimation and compensation block consisting of, a delay estimation unit implemented as time to delay code converter, a clock generator with a provision to toggle between the required frequency (Fo) and a delta frequency F₁=(Fo+ΔF) for a duration of T and back to Fo such that a delay τ=T*(1/Fo−1/(Fo+ΔF)) is introduced at the output clock, and a control unit, that may be a CPU running the control software or a state machine or a combination of the two. The control unit capable of estimating the T and ΔF values based on the estimated delay, such that τ is the delay difference between the primary and secondary sampling clocks with respect to the reference SYNC pulse.

On achieving the delay introduced at the output clock, in the block 550, the DEC 440 changes the frequency of the clock generator to F₀.

As a result, the synchronization technique described above does not require any high speed, low noise sampling clock to be routed on the PCB, avoiding additional components unlike prior-arts discussed in the background section. Further, the technique is capable of compensating systemic delay mismatches by setting different target delay values for the secondary ICs. Further, accuracy of the delay matching is limited only by the delay estimation block and this improves with CMOS manufacturing process node scaling.

While various examples of the present disclosure have been described above, it should be understood that they have been presented by way of example, and not limitation. Thus, the breadth and scope of the present disclosure should not be limited by any of the above described examples, but should be defined in accordance with the following claims and their equivalents.

What is claimed is:

1. A radar system comprising:
a plurality of receivers, each receiver having its clock generator generating a clock signal with a sampling frequency for sampling a radar signal received on one or more receiving antenna; and
a plurality of delay estimation and compensation (DEC) blocks implemented within the corresponding plurality of receivers,
wherein, DEC block is configured to synchronise the clock generator of one receiver with every other receiver.

2. The radar system of claim 1, further comprising a sync pulse generator configured to generate a sync pulse, wherein the sync pulse is routed to the plurality of receivers through a star connection and the DEC block is configured to measure a first delay between the sync pulse and the clock signal.

3. The radar system of claim 2, wherein one of the receivers in the plurality of receiver is operative as primary receiver is configured to transmit the first delay as a reference delay to other receivers configured to operate as a secondary receiver.

4. The radar system of claim 3, wherein the DEC block in the secondary receiver is configured to determine a second delay that is difference of its own first delay and the reference delay.

5. The radar system of claim 4, wherein the DEC block in the secondary receiver is configured to shift the frequency of the clock generator from the sampling frequency to a first frequency for a first time duration following a relation: τ=T*(1/Fₒ−1/(Fo+ΔF)), wherein the T is first time duration, Fₒ is the sampling frequency, τ is the second delay and F₁=(Fₒ+ΔF) is the first frequency with ΔF being a small value relative to Fₒ.

6. A method in a radar receiver implemented with a plurality of receivers with each receiver having its own clock generator generating a clock signal with a sampling frequency for sampling a radar signal received by the respective receivers in the plurality of receivers, the method comprising:
generating a sync pulse in a first receiver in the plurality of receivers;
measuring a delay between the sync pulse and the clock signal in the first receiver;
transmitting the sync pulse to other receiver in the plurality of receivers;
measuring a second delay between the sync pulse and the clock pulse in the other receiver; and
changing the frequency of the clock generator in the other receiver from the sampling frequency to first frequency for a first time duration.

7. The method of claim 6, wherein the frequency of the clock generator is changed maintaining a relation: τ=T*(1/Fₒ−1/(Fo+ΔF)), wherein the T is first time duration, Fₒ is the sampling frequency, τ is the second delay and F₁=(Fₒ+ΔF) is the first frequency with AF being a small value.

8. The method of claim 7, wherein the frequency of the clock generator is changed in a calibration mode operative to synchronize the clock generator of the first receiver and the other receiver.
